(19) United States
(12) Patent Application Publication
(10) Pub. No.: US 2026/0228007 A1
(43) Pub. Date: Aug. 6, 2026

(54) PROCESSOR CORE, OPERATION METHOD THEREOF, AND PROCESSING SYSTEM

(71) Applicant: SAMSUNG ELECTRONICS CO., LTD., Suwon-si (KR)

(72) Inventors: Jaehwan JUNG, Suwon-si (KR); Youngseob CHOI, Suwon-si (KR); Heehyun NAM, Suwon-si (KR); Youngsuk MOON, Suwon-si (KR); Dongmin LEE, Suwon-si (KR); Ranhee LEE, Suwon-si (KR)

(73) Assignee: SAMSUNG ELECTRONICS CO., LTD., Suwon-si (KR)

(21) Appl. No.: 19/300,157

(22) Filed: Aug. 14, 2025

(30) Foreign Application Priority Data
Jan. 31, 2025 (KR) 10-2025-0012678

(51) Int. Cl. G06F 9/30

(52) U.S. Cl. CPC G06F 9/30145; G06F 9/30043; G06F 9/30098

(57) ABSTRACT

A processor core includes an instruction decoder configured to decode a plurality of instructions stored in a program memory and configured to process a read-modify-write (RMW) circuit to process the load operation in a first clock cycle and control a general-purpose load store unit (LSU) circuit to process a first load instruction or a first store instruction subsequent to an RMW instruction and having no dependency on the RMW instruction among the plurality of instructions in a second clock cycle, a register file comprising a plurality of registers, the general-purpose LSU circuit configured to process a load instruction for loading data stored in a memory into one of the plurality of registers and a store instruction for storing data stored in one of the plurality of registers into the memory, and the RMW circuit configured to process the RMW instruction.

### CROSS-REFERENCE TO RELATED APPLICATION(S

This application claims benefit of priority to Korean Patent Application No. 10-2025-0012678 filed on January 31, 2025 in the Korean Intellectual Property Office, the disclosure of which is incorporated herein by reference in its entirety.

### BACKGROUND

Example embodiments of the present disclosure relate to a processor core, a method of operating the processor core and a processing system.

In a processor core supporting a pipeline, processing of an instruction may be divided into several stages. For example, the instruction processing process may be divided into a fetching stage, a decoding stage, an executing stage, and a write-back stage. Since the stages of the pipeline may be executed in sequence in a form in which a plurality of instructions overlap each other in the processor core, high-speed processing of the program may be available.

The processor core may perform a read modify write (RMW) operation of loading data stored in a memory into a register, modifying the loaded data, and storing the modified data back into the memory. While the RMW operation is performed, the resources of the processor core may be occupied by the RMW operation, and the processor core may wait without processing other instructions until the loading operation included in the RMW operation is completed.

### SUMMARY

An example embodiment of the present disclosure is to provide a processor core which may efficiently use processing resources while an RMW operation is performed, and may have an improved throughput.

According to an example embodiment of the present disclosure, a processor core includes an instruction decoder configured to decode a plurality of instructions stored in a program memory, a register file comprising a plurality of registers, a general-purpose load store unit (LSU) circuit configured to process a load instruction for loading data stored in a memory into one of the plurality of registers and a store instruction for storing data stored in one of the plurality of registers into the memory, and a read-modify-write (RMW) circuit configured to process an RMW instruction, the RMW comprising a load operation for loading data stored in the memory into one of the plurality of registers, a compute operation for modifying the loaded data, and a store operation for storing the modified data to the memory. The instruction decoder is configured to process the RMW circuit to process the load operation in a first clock cycle in response to a first RMW instruction among the plurality of instructions, and control the general-purpose LSU circuit to process a first load instruction or a first store instruction subsequent to the first RMW instruction and having no dependency on the first RMW instruction among the plurality of instructions in a second clock cycle, the second clock cycle being subsequent to the first clock cycle.

According to an example embodiment of the present disclosure, an operation method of a processor core includes detecting a first read modify write (RMW) instruction among a plurality of instructions stored in a program memory; computing a memory address of the first RMW instruction; queuing the first RMW instruction in an RMW queue; based on the first RMW instructions having no dependency on a preceding instruction, processing a load operation associated with the first RMW instruction; processing a compute operation for modifying the data loaded into a register based on a load operation; processing a store operation for storing the modified data into the memory; dequeuing the first RMW instruction from the RMW queue; and parallelly processing a second independent RMW instruction subsequent to the first RMW instruction while data stored in the memory is being loaded into the register based on the load operation.

According to an example embodiment of the present disclosure, a processing system includes a processor core including a register, a general-purpose load store unit (LSU) circuit and a read modify write (RMW) circuit; a system bus; and a memory, where subsequent to the RMW circuit processing a load operation in response to a first RMW instruction and while data is loaded from the memory to the register based on a load operation associated with the first RMW instruction, the processor core is configured to control the RMW circuit or the general-purpose LSU circuit to process a subsequent independent instruction having no dependency on the first RMW instruction.

### BRIEF DESCRIPTION OF DRAWINGS

The above and other aspects, features, and advantages of the present disclosure will be more clearly understood from the subsequent to detailed description, taken in combination with the accompanying drawings, in which:

FIG. 1 is a diagram illustrating a processing system according to an example embodiment of the present disclosure;

FIG. 2 is a diagram illustrating a pipeline stage according to an example embodiment of the present disclosure;

FIG. 3 is a diagram illustrating a structure of a processor core according to an example embodiment of the present disclosure;

FIGS. 4A and 4B are diagrams illustrating a process for detecting an RMW instruction according to an example embodiment of the present disclosure;

FIG. 5 is a diagram illustrating an RMW circuit according to an example embodiment of the present disclosure;

FIGS. 6 and 7 are diagrams illustrating a process of processing instructions according to an example embodiment of the present disclosure;

FIG. 8 is a flowchart illustrating a method of processing an RMW instruction according to an example embodiment of the present disclosure;

FIG. 9 is a diagram illustrating a method of accessing a memory according to an example embodiment of the present disclosure;

FIG. 10 is a diagram illustrating an operation of an RMW circuit according to an example embodiment of the present disclosure; and

FIG. 11 is a diagram illustrating a system to which a computation system is applicable according to an example embodiment of the present disclosure.

### DETAILED DESCRIPTION

Hereinafter, embodiments of the present disclosure will be described as below with reference to the accompanying drawings.

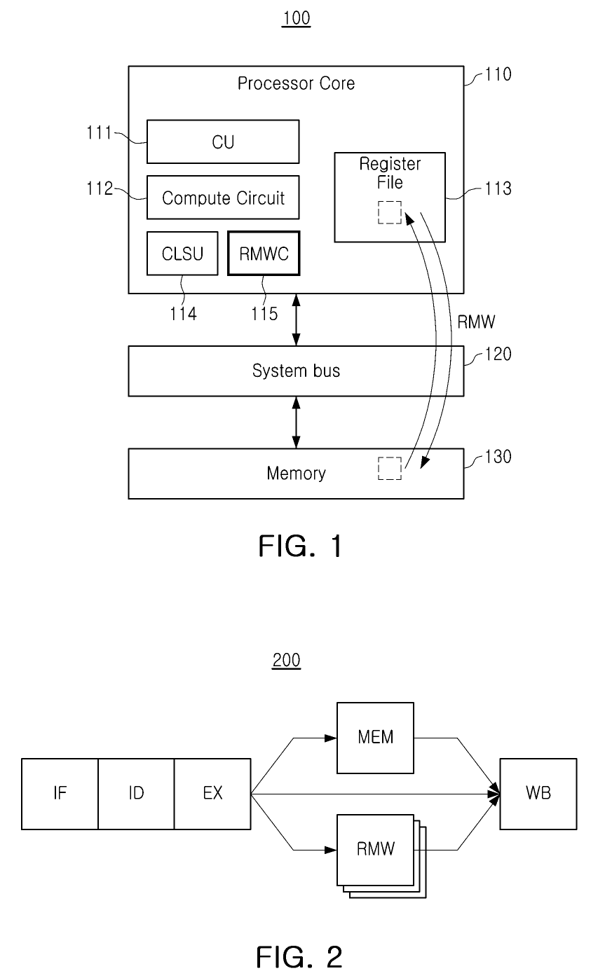

FIG. 1 is a diagram illustrating a processing system according to an example embodiment.

Referring to FIG. 1, a processing system 100 may include a processor core 110, a system bus 120, and a memory 130.

The processing system 100 may be implemented as an embedded system, such as a mobile phone, a smart phone, a tablet personal computer, a wearable device, a healthcare device, an Internet of Things (IoT), a media player, or an automotive device such as a navigation device. However, the processing system 100 is not necessarily limited to an embedded system, and may be implemented as a personal computer, a laptop computer, a server, or the like.

The processor core 110 may execute an instruction and may respond. An instruction executable in the processor core 110 may be defined in ARM, RISC-V, or other instruction set architecture (ISA). The processor core 110 may perform computation on data by executing instructions.

The processor core 110 may be included in a processor such as a central processing unit (CPU), a controller, a digital signal processor (DSP), a microcomputer, a field programmable gate array (FPGA), a programmable logic unit (PLU), a microprocessor, or the like. For example, the processor may include one or more processor cores 110, and may further include a cache memory.

The system bus 120 may support communication between the processor core 110 and external devices of the processor core 110. For example, the system bus 120 may support communication between the processor core 110 and the memory 130, and when the processing system 100 further includes an external device such as a hardware accelerator, communication between the processor core 110 and the external device may be supported. The system bus 120 may include an address bus, a data bus, and a control bus, or the like.

The memory 130 may store data required for the processor core 110 to perform computation. For example, firmware, software, or the like, executable by the processor core 110 may be loaded into the memory 130, and input data and output data of the processor core 110 may be stored in the memory 130. The memory 130 may include a hardware device register such as a special function register (SFRs), and a volatile memory such as a dynamic random access memory (DRAM), a synchronous DRAM (SDRAM), a static RAM (SRAM), and a resistive RAM (RRAM), and may also include a storage device.

The processor core 110 may include a control circuit 111, a compute circuit 112, a register file 113, a general-purpose load store unit (LSU) circuit 114 also referred to as CLSU 114 in FIG. 1), and an RMW circuit 115 (also referred to as RMWC 115 in FIG. 1).

The control circuit 111 may control the processor core 110 to execute instructions. For example, the control circuit 111 may generate control signals based on instruction to be executed, and may provide the control signals to the compute circuit 112, the register file 113, the general-purpose LSU circuit 114, and the RMW circuit 115.

The compute circuit 112 may perform a computation corresponding to an instruction in response to control of the control circuit 111. For example, the compute circuit 112 may include an arithmetic logic unit (ALU) which may perform an arithmetic computation, a floating point unit (FPU) which may perform a floating-point computation, or the like.

The register file 113 may include a plurality of registers. For example, the registers may include a program counter, an instruction register, a data register, a memory address register, a memory buffer register, or the like. The compute circuit 112 may access the registers and may obtain a register value required for computation, and may store the computation results in the register. Depending on the type of register, the register value stored in the register may be an address of program memory, a register, general data, a memory address, or the like. However, in example embodiments, the register value may be generally referred to as data.

The processor core 110 may load the data stored in the memory 130 into a register to perform a computation on the data, and may store the computation result stored in the register into the memory 130. The time taken for the processor core 110 to access the memory 130 externally of the processor core 110 may be longer than the time taken for the processor core 110 to process computation internally. For example, several tens of clock cycles may be taken for the processor core 110 to execute a load instruction and for data to be loaded into a designated register in response to the load instruction.

In the processing system 100, such as an embedded system, a read modify write (RMW) operation in which the processor core 110 reads data from the memory 130, modifies the data, and writes the modified data to the memory 130 may occur frequently. The RMW operations frequently performed may cause, however, performance degradation of the processor core 110.

For example, the processor core 110 may execute a load instruction, may modify the loaded data by executing a computation instruction for the loaded data after the data is loaded into the register in response to the load instruction, and may execute a store instruction on the modified data. When the processor core 110 stalls while the computation instruction and the store instruction are not processed until the data is loaded, and other subsequent instructions are not processed, dozens of clock cycles may be wasted.

The processing system 100 may include a hardware accelerator supporting processing of a portion of functions more swiftly than being executed on the processor core 110. For example, the processor core 110 may request an RMW operation from the hardware accelerator, and may execute other subsequent instructions even before the RMW operation is completed. However, when the hardware accelerator is external to the processor core 110 and the processor core 110 is able to communicate with the hardware accelerator through the system bus 120, several dozen clock cycles may be taken to request a load operation included in the RMW operation to the hardware accelerator.

According to an example embodiment, the processor core 110 may include a general-purpose LSU circuit 114 and an RMW circuit 115 for loading data from the memory 130 or storing data to the memory 130. The general-purpose LSU circuit 114 may process a general load operation and a store operation of the processor core 110. The RMW circuit 115 may process the load operation and the store operation accompanying the RMW operation. The general-purpose LSU circuit 114 and the RMW circuit 115 may process the load operation and the store operation independently of each other.

The processor core 110 may process a load operation included in the RMW operation in the RMW circuit 115, and may process a load operation and a store operation having no dependency on the RMW operation in the general-purpose LSU circuit 114 while data is loaded into a register in response to the load operation. Also, the processor core 110 may process another RMW operation having no dependency on the RMW operation in the RMW circuit 115 while data is loaded into a register in response to the load operation.

By further including the RMW circuit 115 for the RMW operation internally, the processor core 110 may require only one clock cycle to process the load operation included in the RMW operation, and may process other operations having no dependency on the load operation after the load operation is processed. Accordingly, the time during which the processor core 110 is stalled, e.g., the processor is idle or awaiting data before processing, may be reduced, and the throughput of the processor core 110 may be improved.

FIG. 2 is a diagram illustrating a pipeline stage according to an example embodiment.

The processor core 110 described with reference to FIG. 1 may include a processing pipeline 200. The processor core 110 may divide an execution process of an instruction into several stages to efficiently process an instruction, and may perform the stages in parallel, thereby increasing processing efficiency and improving performance.

Referring to FIG. 2, the processing pipeline 200 may include a fetching stage IF, a decoding stage ID, an executing stage EX, a memory stage MEM, and a write-back stage WB.

In the fetching stage IF, the processor core 110 may load an instruction from a program memory included in the memory 130 described with reference to FIG. 1. For example, the processor core 110 may determine a memory address of an instruction to be currently loaded using a program counter value, may load an instruction at the determined memory address, and may update the program counter to load the subsequent instruction.

In the decoding stage ID, the processor core 110 may analyze the fetched instruction and may interpret which operation should be executed. For example, the processor core 110 may extract the operation code (Opcode) of the instruction, may determine the type of the instruction, and may load the necessary data from the register file 113 described with reference to FIG. 1 by referencing the register number included in the instruction.

In the executing stage EX, the processor core 110 may execute a computation using the loaded data. For example, the processor core 110 may perform an arithmetic computation, logical computation, floating-point computation, or the like, on general data, and may also perform a memory address computation.

In the memory stage MEM, the processor core 110 may perform a load operation of loading data stored in the computed memory address into a register, or a store operation of storing data in the register to the computed memory address.

In an example embodiment, a portion of instructions may not include memory access. For instructions not including memory access, the memory stage MEM may be skipped.

In the write-back stage WB, the processor core 110 may prepare a subsequent instruction to use the data stored in the register by writing the computation result to a register.

An instruction may be processed by executing the stages of the processing pipeline 200 in sequence in each clock cycle. Each stage of the processing pipeline 200 may be processed in parallel. For example, a first instruction may be fetched in the first clock cycle, and a second instruction, which is the instruction subsequent to the first instruction, may be fetched simultaneously as the first instruction is decoded in the second clock cycle, which is the cycle subsequent to the first clock cycle.

Since the processing pipeline 200 may process a plurality of instructions in parallel, the processing resources of the processor core 110 may be efficiently used, and a throughput of the processor core 110 may be improved.

As described with reference to FIG. 1, tens of clock cycles may be taken for the processor core 110 to access the memory 130. However, when there is no dependency between instructions performing the memory access operation, the memory access operation may be processed in the processing pipeline 200 without delaying clock cycles.

For example, the processor core 110 may process the load instruction by outputting a control signal to load data stored in the memory 130 from the memory stage MEM into a register in response to the load instruction. Tens of clock cycles may be taken for the data to actually be stored in the register after the load instruction is processed. However, when instructions subsequent to the load instruction do not reference data stored in the register, the subsequent instructions may be processed without being delayed until data is stored in the register.

An RMW operation may include a load operation of loading data from the memory 130 into a register, a compute operation of modifying the data loaded into the register, and a store operation of storing the modified data into the memory 130. That is, since there is a dependency between the load operation included in the RMW operation and the compute operation, the compute operation may have to be performed after the data is stored in the register based on the load operation. When the processor core 110 is stalled without processing instructions subsequent to the compute operation, the store operation, and the RMW operation until the data is actually loaded into the register in response to the load operation, dozens of clock cycles may be wasted.

According to an example embodiment, while the memory stage MEM processes the load operation included in the RMW operation and the data is actually loaded into the register in response to the read operation, subsequent instructions having no dependency on the RMW operation may be processed. Accordingly, the time during which the processor core 110 is stalled may be reduced, and processing resources may be used efficiently. This parallel implementation is shown in FIG. 2 schematically through the RMW stage in processing pipeline 200.

For example, the processor core 110 may process a load operation included in a first RMW operation in a memory stage MEM in a first clock cycle, and may process a load instruction or a store instruction having no dependency on the first RMW operation in a memory stage MEM in a second clock cycle subsequent to the first clock cycle, or may process a load operation included in a second RMW operation having no dependency on the first RMW operation. The processor core 110 may perform the compute operation and the store operation included in the first RMW operation after data is actually loaded into a register in response to the load operation.

The processor core 110 may include an RMW circuit for performing the RMW operation together with a general-purpose LSU circuit for performing a general memory access operation. The RMW circuit may include a circuit for performing a load operation and a store operation similar to the general-purpose LSU circuit, and in example embodiments, a computation circuit for performing a compute operation may be further included.

The processor core 110 may process a load operation included in the first RMW operation in the RMW circuit and may process subsequent memory access operations in the general-purpose LSU circuit while data is loaded into a register. Also, the processor core 110 may process a load operation included in the second RMW operation in the RMW circuit while data is loaded into a register after processing the load operation included in the first RMW operation in the RMW circuit.

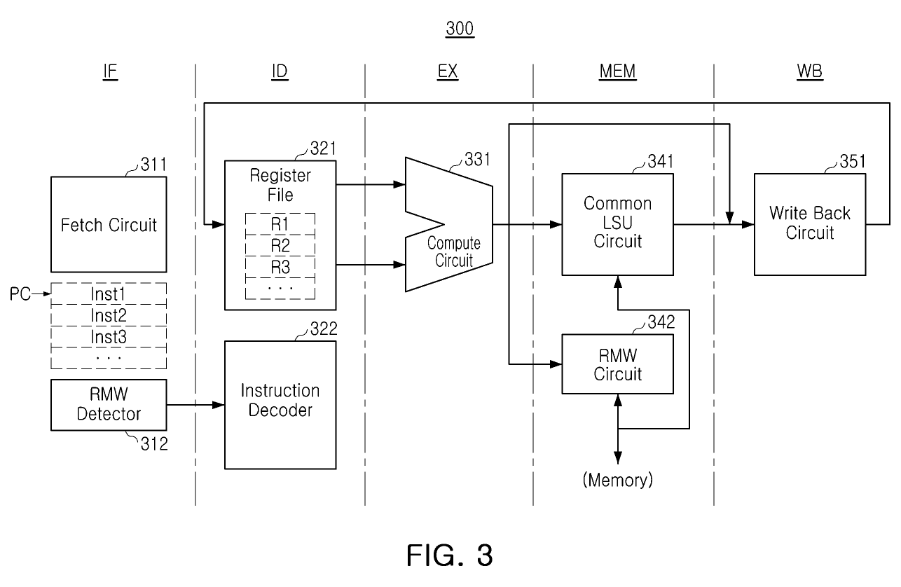

Hereinafter, the structure of a processor core according to an example embodiment will be described in detail with reference to FIGS. 3 to 5.

FIG. 3 is a diagram illustrating a structure of a processor core according to an example embodiment.

As described with reference to FIG. 2, a processing pipeline may include a fetching stage IF, a decoding stage ID, an executing stage EX, a memory stage MEM, and a write-back stage WB. FIG. 3 illustrates a structure of a processor core 300 included in the processing pipeline.

The processor core 300 may include a fetch circuit 311 and a RMW detector 312 included in the fetching stage IF, and a register file 321 and an instruction decoder 322 included in the decoding stage ID. The processor core 300 may include a compute circuit 331 included in the executing stage EX, and a general-purpose LSU circuit 341 (referred to as common LSU circuit 341 in FIG. 3) and a RMW circuit 342 included in the memory stage MEM. The processor core 300 may also include a write-back circuit 351 included in the write-back stage WB. The processor core 300 may further include registers for transferring a state of a previous stage to a subsequent stage between stages.

In the fetching stage IF, the fetch circuit 311 may fetch instructions stored in the program memory in sequence. The program memory may store a plurality of instructions, and the fetch circuit 311 may fetch an instruction pointed to by the program counter among the plurality of instructions.

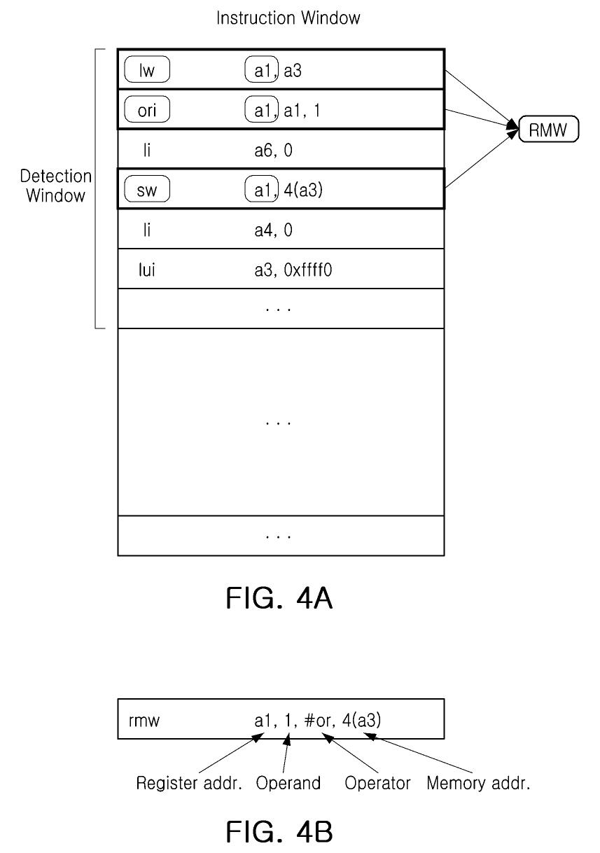

According to an example embodiment, the RMW detector 312 may detect a RMW instruction among the instructions stored in the program memory. An example of a method by which the RMW detector 312 detects a RMW instruction will be described below with reference to FIGS. 4A and 4B.

In the decoding stage ID, the instruction decoder 322 may decode the instruction fetched by the fetch circuit 311, and may provide control signals to circuits such as the compute circuit 331, the common LSU circuit 341, the RMW circuit 342, and the write-back circuit 351 according to the decoded result. It will be understood that the general-purpose LSU circuit is interchangeably referred to as common LSU circuit or CLSU herein.

In an example embodiment, the instruction decoder 322 may provide a control signal to the RMW circuit 342 in the memory stage MEM when the fetched instruction is a RMW instruction, may provide a control signal to the common LSU circuit 341 when the fetched instruction is a load instruction or a store instruction not included in a RMW instruction, and may not provide a control signal to the memory stage MEM when the fetched instruction does not include a memory access operation.

The register file 321 may include a plurality of registers R1, R2, and R3, each of which may store data. For example, the data may include general data, a memory address, or the like. In the executing stage EX, before the instruction is executed, data may be prepared in the registers associated with the instruction.

In the executing stage EX, the compute circuit 331 may obtain data from the register, may perform a computation indicated by the instruction on the data, and may output the computation result.

In the memory stage MEM, a memory access may be performed based on the computation result. For example, in the case of a load instruction or a store instruction, a memory address to be accessed by the compute circuit 331 may be computed, and the common LSU circuit 341 may access the computed memory address. For example, the common LSU circuit 341 may provide data to or obtain data from the memory 130 using the system bus 120 as described with reference to FIG. 1.

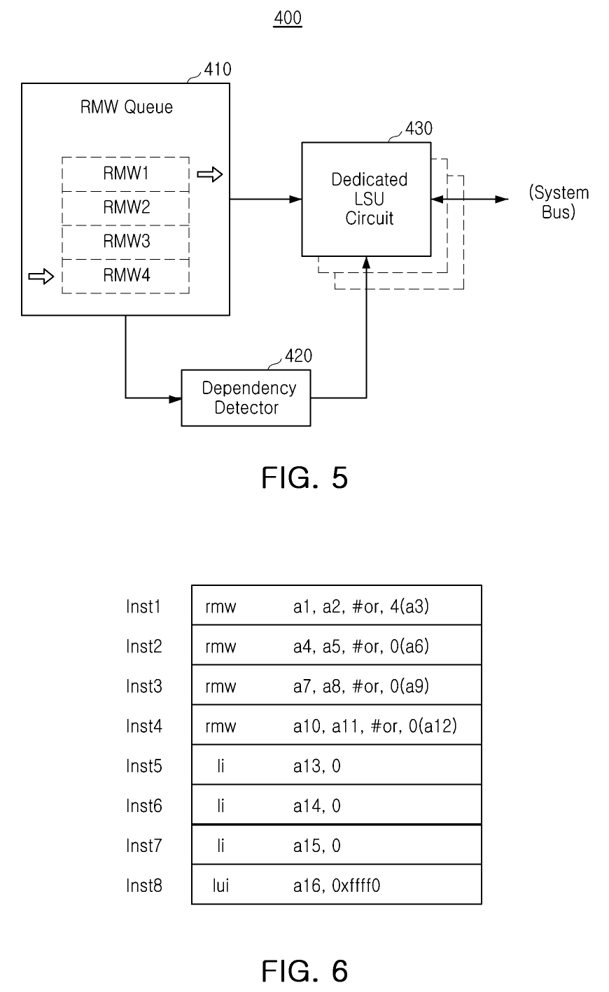

According to an example embodiment, a load operation, a compute operation and a store operation included in the RMW instruction may be performed by the RMW circuit 342. While the RMW circuit 342 executes a load operation based on the first RMW instruction and waits until data corresponding to the load operation is loaded into a register, the common LSU 341 may access memory based on subsequent instructions having no dependency on the first RMW instruction. Also, while the RMW circuit 342 waits for data corresponding to the first RMW instruction to be loaded into a register, the RMW circuit 342 may access memory based on other subsequent RMW instructions having no dependency. An exemplary structure of the RMW circuit 342 according to an example embodiment will be described below with reference to FIG. 5.

In an example embodiment, as for an instruction not including a memory access, no operation may be performed in the memory stage MEM and the memory stage MEM may be skipped.

In the write-back stage WB, the write-back circuit 351 may store the computation result of the compute circuit 331 into the register of the register file 321.

According to an example embodiment, while waiting for data corresponding to the first RMW instruction to be loaded into the register, the processor core 300 may stall the processing pipeline and may process subsequent instructions. Accordingly, resources of the processor core 300 may be efficiently used, a clock cycle per instruction (CPI) may be reduced, and a throughput may be increased.

FIGS. 4A and 4B are diagrams illustrating a method for detecting an RMW instruction according to an example embodiment.

In an example embodiment in FIG. 4A, the RMW instruction may not be defined as a single instruction. When a load instruction, a computation instruction, and a store instruction for a register address need to be processed in order, a set of the load instruction, the computation instruction, and the store instruction may be defined as an RMW instruction.

The program memory may store a predetermined number of instructions to be performed in order. The RMW detector 312 may detect the set of the load instruction, the computation instruction, and the store instruction for a predetermined range of consecutive instructions among the instructions stored in the program memory. The range of instructions stored in the program memory may be referred to as an instruction window. The range defined for the RMW detector 312 to detect the instruction set may be referred to as a detection window. For example, the instruction window may include 32 instructions, and the detection window may include 8 instructions to be processed preferentially in the instruction window.

In the example in FIG. 4A, a load instruction lw, a computation instruction ori, and a store instruction sw for the first register a1 may be included in order in the detection window. Specifically, the load instruction lw may request to load the data stored in the memory address stored in the third register a3 into the first register a1, the computation instruction ori may request to OR operation of the data loaded in the first register a1 and ‘1’, and the store instruction sw may request to store the computation result stored in the first register a1 into the memory address added by ‘4’ from the third register a3.

The RMW detector 312 may detect the instruction set as an RMW instruction when the load instruction, the computation instruction, and the store instruction for the same register address, and when the load instruction, the computation instruction, and the store instruction are included in the detection window in sequence, and may provide a detect signal to the instruction decoder 322 described with reference to FIG. 3.

The RMW detector 312 may detect the instruction set as an RMW instruction when no dependency is present in the intervening instructions. This is to ensure that the instruction is recognized as a set even when the load instruction, the computation instruction, and the store instruction included in the order are not consecutive.

In the example of 4A, a load instruction li which requests to load a sixth register a6 with a constant ‘0’ may be included between the computation instruction ori and the store instruction sw. However, since the load instruction li accesses a register different than the computation instruction ori and the store instruction sw, that is no dependency between li and the computation instruction ori and the store instruction sw. Accordingly, the RMW detector may detect the load instruction lw for the first register a1, the computation instruction ori and the store instruction sw as RMW instructions.

FIG. 4A illustrates an example in which the RMW instruction is defined as an instruction set, rather than a single instruction. However, an example embodiment thereof is not limited thereto.

In an example embodiment in FIG. 4B, the RMW instruction may be defined as a single instruction. That is, the processor core may be requested to perform a load operation, a compute operation, and a store operation for a register address in sequence in response to the RMW instruction.

In an example embodiment, the RMW instruction may include a register address (Register addr.), operand (Operand), operator (Operator), and memory address (Memory addr.).

A memory address may instruct a source address to which data is loaded, and a destination address in which modified data is stored in a memory. A memory address may include a register address storing the memory address and an offset.

For example, ‘4(a3)’ in FIG. 4B may indicate that data is loaded from a memory address stored in a third register a3, the data is modified, and the modified data is stored in a memory address to which an offset of ‘4’ is added from the memory address. That is, the source address may be a memory address stored in third register a3, and the destination address may be a memory address to which an offset of ‘4’ is added from the memory address. When the source address and the destination address are the same, the memory address may be indicated as ‘0(a3).’ It will be understood that this disclosure is not limited thereto.

The register address may instruct a register in which data loaded from the memory is stored. For example, ‘a1’ in FIG. 4B may indicate a first register a1 in which data loaded from a memory address stored in the third register a3 is stored.

The operator may instruct an operator for modifying data loaded into a register. In an example embodiment, the operator may include an OR operator, an AND operator, or the like, for masking computation. The operand may indicate an operand for modifying data loaded into a register. In the example in FIG. 4B, ‘#or’ which is the operator and ‘1’ which is the operand may instruct OR operation of data loaded into the first register a1 and ‘1’. In an example embodiment, the operand may refer to a constant or a register address in which data to be computed is stored.

According to an example embodiment, when the RMW instruction is defined as a single instruction, the RMW detector 312 may detect the instruction as the RMW instruction. However, an example embodiment thereof is not limited thereto. For example, when the RMW instruction is defined as only a single instruction, the processor core 300 may not include the RMW detector 312, and may detect the RMW instruction by decoding the fetched instruction in the instruction decoder 322.

An RMW circuit 342 described with reference to FIG. 3 may be controlled based on the RMW instruction in the instruction decoder 322. For example, the instruction decoder 322 may determine a register address, an operand, an operator, and a memory address by decoding the instruction set in FIG. 4A or the RMW instruction in FIG. 4B, and may provide a control signal to the RMW circuit 342. The RMW circuit 342 may perform an RMW operation in response to the control signal.

FIG. 5 is a diagram illustrating an RMW circuit according to an example embodiment.

The RMW circuit 400 may include a RMW queue 410, a dependency detector 420, and a dedicated LSU circuit 430. The RMW circuit 400 in FIG. 5 may correspond to the RMW circuit 342 described with reference to FIG. 3.

The RMW queue 410 may queue decoded RMW instructions RMW1-RMW4. The RMW instructions RMW1-RMW4 may be queued in the order in which execution is completed in the executing stage EX described with reference to FIG. 3. Each of the queued RMW instructions RMW1-RMW4 may be dequeued in the order in which the load operation, the compute operation, and the store operation are completed.

The dependency detector 420 may detect dependencies on other instructions for each of the queued RMW instructions RMW1-RMW4. For example, dependency between queued RMW instructions RMW1-RMW4 may be detected, and dependency on other memory access instructions may be further detected. Depending on the dependency of RMW instructions RMW1-RMW4, the execution order of the load operation, the compute operation, and the store operation included in the RMW instructions RMW1-RMW4 may be scheduled.

The dedicated LSU circuit 430 may process the load operation, the compute operation, and the store operation for each of the RMW instructions RMW1-RMW4 queued in the RMW queue 410. In an example embodiment, the dedicated LSU circuit 430 may include a circuit for performing the load operation and the store operation similarly to the common LSU circuit 341 described with reference to FIG. 3.

In an example embodiment, the dedicated LSU circuit 430 may further include a computation circuit (e.g., compute circuit 331) for modifying the loaded data. For example, the compute operation included in the RMW instruction may be one of the computations for masking bits, such as an AND operation and an OR operation. The computation circuit may include a circuit which may perform an AND operation and an OR operation.

According to an example embodiment, while a load operation of an RMW instruction is processed in the dedicated LSU circuit 430 and data is loaded into a register, memory access instructions may be processed in the common LSU circuit 341 described with reference to FIG. 3.

The RMW circuit 400 may process operations of another RMW instruction while data corresponding to a certain RMW instruction is loaded in the dedicated LSU circuit 430.

In an example embodiment, the RMW circuit 400 may include a plurality of dedicated LSU circuits 430. The dependency detector 420 may selectively enable the plurality of dedicated LSU circuits 430 depending on whether a dependency is present between RWM instructions.

For example, instructions having dependencies may need to be processed in order. Accordingly, when queued RMW instructions have dependencies, the dependency detector 420 may enable only one dedicated LSU circuit 430 and may control that RMW instructions to be processed in order in the one dedicated LSU circuit 430. On the other hand, among the queued RMW instructions, instructions without dependencies may control the dependency detector 420 to enable the plurality of dedicated LSU circuits 430 and instructions without dependencies in each of the plurality of dedicated LSU circuits 430 may control the RMW instructions to be processed in parallel.

In an example embodiment, the RMW circuit 400 may include a single dedicated LSU circuit 430, and the load operation, the compute operation and the store operations included in each RMW instruction may be scheduled in a single dedicated LSU circuit 430. For example, among queued RMW instructions without dependencies, the load operations of the RMW instructions may be processed in sequence in the order in which the RMW instructions are queued in the dedicated LSU circuit 430. The compute operations and store operations of the RMW instructions may be processed in sequence in the order in which data is loaded in response to the read operations. Between RMW instructions having dependencies, a subsequent RMW instruction may be processed after the processing of a preceding RMW instruction is completed in the dedicated LSU circuit 430.

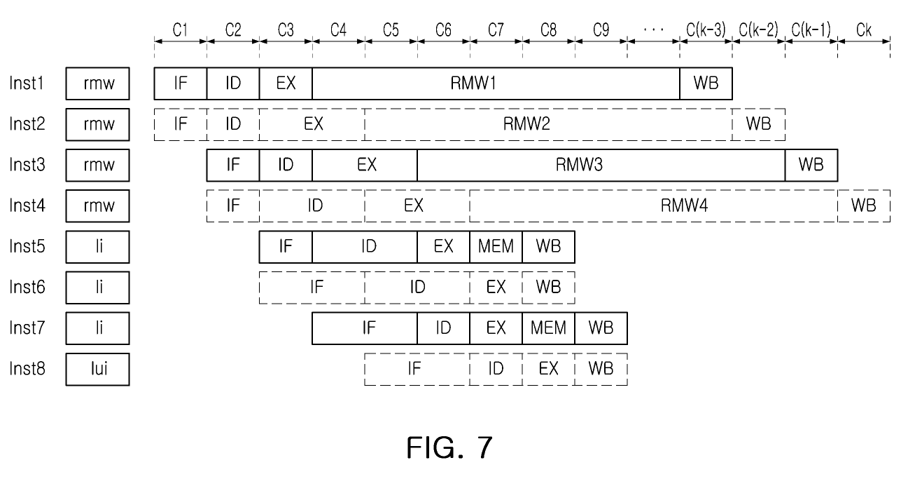

FIGS. 6 and 7 are diagrams illustrating a process of processing instructions according to an example embodiment.

FIG. 6 illustrates instructions Inst1-Inst8 fetched in order.

In the example in FIG. 6, among the instructions Inst1-Inst8 fetched in order, preceding first to fourth instructions Inst1 to Inst4 may be RMW instructions, and succeeding fifth to eighth instructions Inst5 to Inst8 may be load instructions. For example, the fifth instruction Inst5 may be an instruction that loads the constant ‘0’ into the thirteenth register a13, and the eighth instruction Inst8 may be an instruction that loads ‘0xffff0’ into the upper bits of the sixteenth register a16. Since the instructions Inst1-Inst8 may access different registers a1 toa16, the instructions may not have dependencies on each other.

FIG. 7 illustrates clock cycles in which the instructions in FIG. 6 are processed.

In an example embodiment, the processor core may be a dual-issue processor core which may move a pair of instructions to subsequent stages in a single clock cycle. In the example in FIG. 7, one of the pair of instructions is illustrated as a solid line and the other is illustrated as a dashed line.

In a first clock cycle C1, the first and second instructions Inst1 and Inst2 may be fetched. In a second clock cycle C2, the first and second instructions Inst1 and Inst2 may be decoded, and the third and fourth instructions Inst3 and Inst4 may be fetched. In a third clock cycle C3, the first and second instructions Inst1 and Inst2 may be executed, the third and fourth instructions Inst3 and Inst4 may be decoded, and the fifth and sixth instructions Inst5 and Inst6 may be fetched. That is, because the instructions are independent, their execution may be cascaded.

In the executing stage EX of the first and second instructions Inst1 and Inst2, which are RMW instructions, memory address computation for a memory address of each of the first and second instructions Inst1 and Inst2 may be performed. For example, the memory address of the first instruction Inst1 may be ‘4(a3)’, and in the executing stage EX, a computation to determine the memory address stored in the third register a3 as the source address, and to determine the destination address by adding ‘4’ to the source address may be performed.

RMW instructions may be queued in sequence in the RMW queue. In the fourth clock cycle C4, the first instruction Inst1 may be queued in the RMW queue 410 described with reference to FIG. 5, and the second instruction Inst2 may be stalled or await processing in the executing stage EX. The third instruction Inst3 may be executed, the fifth instruction Inst5 may be decoded, and the seventh instruction Inst7 may be fetched. Since the second instruction Inst2 is stalled or await processing at the executing stage EX, the fourth instruction Inst4 may be stalled or await processing at the decoding stage ID, and the sixth instruction Inst6 may be stalled or await processing at the fetching stage IF.

In the fifth clock cycle C5, the second instruction Inst2 may be queued in the RMW queue 410, the fourth instruction Inst4 may be executed, the sixth instruction Inst6 may be decoded, and the eighth instruction Inst8 may be fetched. While the second instruction Inst2 is queued in the RMW queue 410, the third instruction Inst3 may be stalled or await processing at the executing stage EX, the fifth instruction Inst5 may be stalled or await processing at the decoding stage ID, and the seventh instruction Inst7 may be stalled or await processing at the fetching stage IF.

In the sixth clock cycle C6, the third instruction Inst3 may be queued in the RMW queue 410, the fifth instruction Inst5 may be executed, and the seventh instruction Inst7 may be decoded. While the third instruction Inst3 is queued in the RMW queue 410, the fourth instruction Inst4 may be stalled or await processing at the executing stage EX, the sixth instruction Inst6 may be stalled or await processing at the decoding stage ID, and the eighth instruction Inst8 may be stalled or await processing at the fetching stage IF.

In the seventh clock cycle C7, the fourth instruction Inst4 may be queued in the RMW queue 410, the sixth instruction Inst6 may be executed, and the eighth instruction Inst8 may be decoded. The fifth instruction Inst5 may be a load operation not requiring memory access, but the fifth instruction Inst5 may be moved to the memory stage MEM such that the instruction may be completed in the same clock cycle as the sixth instruction Inst6, and the seventh instruction may be executed.

In the eighth clock cycle C8, the write-back operation of the fifth and sixth instructions Inst5 and Inst6 may be performed, and the fifth and sixth instructions Inst5 and Inst6 may be completed. The seventh instruction Inst7 may be a load operation not requiring memory access, but the seventh instruction Inst7 may be moved to the memory stage MEM such that the instruction may be completed in the same clock cycle as the eighth instruction Inst8, and the eighth instruction may be executed.

In the ninth clock cycle C9, the write-back operation of the seventh and eighth instructions Inst7 and Inst8 may be performed, and the seventh and eighth instructions Inst7 and Inst8 may be completed.

In the case of the first to fourth instructions Inst1 to Inst4, dozens to tens of clock cycles may be taken while waiting for the load operations to be performed and the data to be actually loaded into the register, and in the subsequent clock cycles C(k-3) to Ck, the write-back operation of the first to fourth instructions Inst1-Inst4 may be performed in sequence and completed.

According to an example embodiment, the load operations included in the first to fourth instructions Inst1 to Inst4, which are RMW instructions, may be performed, and while waiting for the data to be actually loaded into the register, the subsequent instructions, the fifth to eighth instructions Inst5 to Inst8, may be completed. Also, the first to fourth instructions Inst1 to Inst4, which are RMW instructions, may wait in parallel until the data is actually loaded into the register.

According to an example embodiment, processing resources may be efficiently used in a processor core in which RMW instructions are performed at a high rate, such as in an embedded environment, and the throughput of the processor core may be improved.

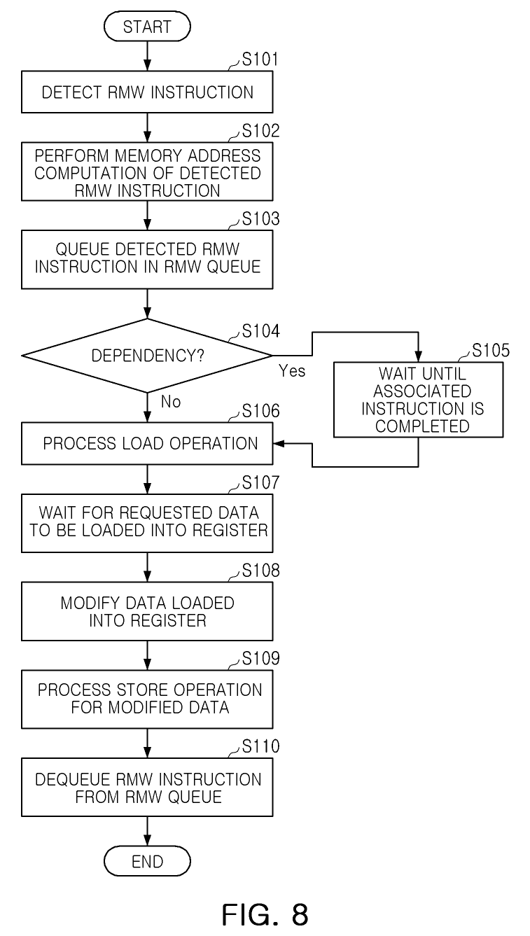

FIG. 8 is a diagram illustrating a method of processing an RMW instruction according to an example embodiment.

In operation S101, an RMW instruction may be detected among fetched instructions.

In an example embodiment, when an RMW instruction is configured as an instruction set including a load instruction, a computation instruction, and a store instruction, operation S101 may be performed in the RMW detector 312 described with reference to FIG. 3. In an example embodiment, when the RMW instruction is defined as a single instruction, operation S101 may be performed in the instruction decoder 322 as described with reference to FIG. 3.

In operation S102, a memory address computation of the detected RMW instruction may be performed. As described with reference to FIG. 4B, the RMW instruction may include a memory address instructed based on a register address, and a source address and a destination address may be determined by performing an arithmetic computation on data stored in a register referred to by the register address in the compute circuit 331 described with reference to FIG. 3.

In operation S103, the detected RMW instruction may be queued in the RMW queue 410 as described with reference to FIG. 5.

In operation S104, whether a dependency is present between the queued RMW instruction and a preceding instruction may be determined. For example, when the preceding instruction is an RMW instruction or a store instruction having the same register address as the queued RMW instruction, a dependency may be present between the queued RMW instruction and the preceding instruction. On the other hand, when the preceding instruction is a load instruction, no dependency may be present even when the queued RMW instruction and the register address are the same.

When a dependency is present between the queued RMW instruction and the preceding instruction (“Yes” in operation S104), in operation S105, the RMU circuit 400 described with reference to FIG. 5 may wait for execution of the queued RMW instruction until the associated instruction is completed, and may perform operation S106.

When there is no dependency between the queued RMW instruction and the preceding instruction (“No” in operation S104), in operation S106, a load operation included in the queued RMW instruction may be processed. For example, the load operation may be processed in the dedicated LSU circuit 430 described with reference to FIG. 5. The load operation may be processed by outputting a control signal to the system bus requesting data to the memory address in which the data to be loaded is stored. However, at least a dozen clock cycles may be taken until the data is loaded into the register in response to the load operation.

In operation S107, the RMU circuit 400 may wait for execution of the queued RMW instruction until the requested data is loaded into the register.

According to an example embodiment, in operation S107, the RMW circuit 400 may process a load operation of a subsequent RMW instruction while waiting for execution of the queued RMW instruction, or may process a compute operation and a store operation of a preceding RMW instruction. Also, the common LSU circuit 341 described with reference to FIG. 3 may process subsequent memory access instructions, and instructions not requiring memory access may also be processed by skipping the memory stage MEM.

When data is loaded into a register, the loaded data may be modified in operation S108. For example, the dedicated LSU circuit 430 may perform the load operation and the store operation, and also the designated compute operations. The dedicated LSU circuit 430 may perform the compute operation by referencing an operator and an operand of the queued RMW instruction.

However, an example embodiment is not limited to the example in which the dedicated LSU circuit 430 performs a compute operation. For example, the loaded data may be stored in a register in the write-back stage WB described with reference to FIG. 3, and the data may be modified by repeating the executing stage EX.

In operation S109, a store operation for the modified data may be processed. For example, in the dedicated LSU circuit 430, the store operation may be processed by outputting a control signal including the data to be stored and a memory address to which the data is to be stored to the system bus.

In operation S110, the queued RMW instruction may be dequeued in the RMW queue 410. The RMW instruction removed from the RMW queue 410 may be processed in the write-back stage WB, and the processing of the RMW instruction may be completed by writing the modified data back to a designated register.

In the example in FIG. 7, the example in which the first to fourth instructions Inst1-Inst4, which are RMW instructions, are processed in clock cycles of the same length is described, but an example embodiment thereof is not limited thereto. For example, depending on the position of the memory which the processor core desires to access, the time from when the load operation is processed to when the data is loaded into the register may vary, and the processing period may vary for each RMW instruction.

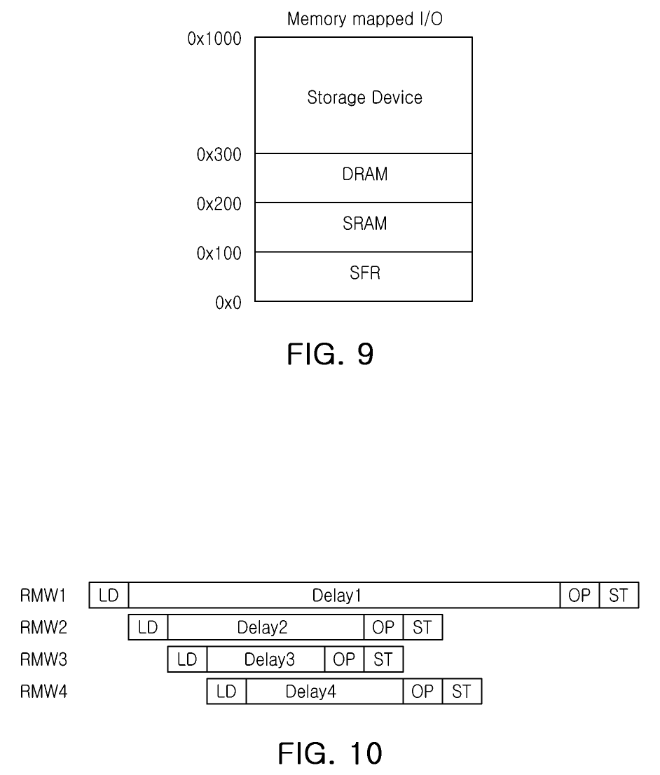

Hereinafter, a method of processing an RMW instruction according to an example embodiment will be described in detail with reference to FIGS. 9 and 10.

FIG. 9 is a diagram illustrating a method of accessing a memory according to an example embodiment.

A processing system 100 described with reference to FIG. 1 may support memory-mapped input/output (MMIO). MMIO may refer to a method of mapping the memory region of a memory 130 to a memory address space of a processor core 110 when performing memory input/output in the processor core 110.

The memory 130 may provide a memory space including a plurality of memories. For example, the memory 130 may include a hardware device register, a volatile memory device, and a storage device. In the example in FIG. 9, the memory 130 may include a special function register (SFR), a static random access memory (SRAM), and a dynamic random access memory (DRAM), and a storage device. MMIO may support software to easily access the memory region of hardware devices by mapping the memory region of hardware devices to the address space 0x0 to 0x1000 of a processor core. For example, memory spaces of a special function register (SFR), a static random access memory (SRAM), and a dynamic random access memory (DRAM), and a storage device may be mapped to consecutive memory addresses.

The time required for the processor core 110 to access heterogeneous memory devices such as SFR, SRAM, DRAM and storage device may vary, and the time required to access the same memory device may also vary depending on the memory position. That is, when the processor core 110 processes an RMW instruction, the number of clock cycles required to actually load data into a register in response to a load operation depending on the memory address may vary.

According to an example embodiment, the RMW circuit may complete the processing of the RMW instructions by performing a compute operation and a store operation in the order in which data required to process the queued RMW instructions are loaded.

FIG. 10 is a diagram illustrating an operation of an RMW circuit according to an example embodiment.

In the RMW circuit 400 described with reference to FIG. 5, a plurality of RMW instructions RMW1-RMW4 may be queued in sequence in the RMW queue 410. Each RMW instruction may include a load operation LD of loading data from a memory to a register, a compute operation OP of modifying the loaded data, and a store operation ST of storing the modified data to the memory. In an example embodiment, a dedicated LSU circuit 430 may perform the load operation LD, the compute operation OP, and the store operation ST.

According to an example embodiment, the dedicated LSU circuit 430 may process the load operation LD in the order in which the RMW instructions RMW1-RMW4 are queued, may process the compute operation OP and the store operation ST of the RMW instructions RMW1 toRMW4 in the order in which the data is loaded into the memory, and may dequeue the RMW instructions RMW1 toRMW4 in the RMW queue 410 in the order in which they are completed. Among RMW instructions having dependency on each other, the subsequent RMW instruction may be processed after the processing of the preceding RMW instruction is completed.

In the example in FIG. 10, the first to fourth RMW instructions RMW1 toRMW4 may not have dependency on each other. The dedicated LSU circuit 430 may process the load operation LD in the order of the first to fourth RMW instructions RMW1 toRMW4 by referencing the RMW queue 410. The delay times Delay1 toDelay4 required for data to be loaded into the register in each of the first to fourth RMW instructions RMW1 toRMW4 may be different. For example, the data of the RMW instruction of which load operation LD is processed earlier may be loaded later than the data of the RMW instruction of which load operation LD is processed later.

The dedicated LSU circuit 430 may process the compute operation OP and the store operation ST of the RMW instructions RMW1 toRMW4 in the order in which the data is loaded into the memory. In the example in FIG. 10, the compute operation OP and the store operation ST may be processed in the order of the third RMW instruction RMW3, the second RMW instruction RMW2, the fourth RMW instruction RMW4 and the first RMW instruction RMW1. That is, depending on the time required for data to be loaded, the order of completion among RMW instructions without dependency may be different from the order in which the instructions are queued.

According to an example embodiment, the RMW circuit 400 may efficiently use the resources of the dedicated LSU circuit 430 and may improve a throughput of the RMW instructions by scheduling the load operation LD, the compute operation OP and the store operation ST.

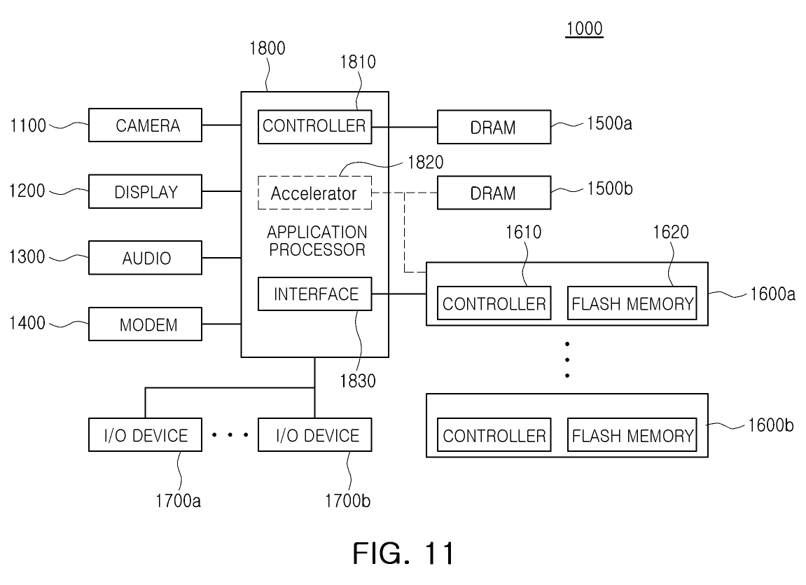

FIG. 11 is a diagram illustrating a system to which a computation system is applicable according to an example embodiment.

Referring to FIG. 11, the system 1000 may include a camera 1100, a display 1200, an audio processing portion 1300, a modem 1400, a DRAMs 1500a and 1500b, flash memory devices 1600a and 1600b, I/O devices 1700a and 1700b, and an application processor (hereinafter, “AP”) 1800.

The system 1000 may be implemented as a laptop computer, a portable terminal, a smartphone, a tablet PC, a wearable device, a healthcare device, or an IoT (Internet-of-Things) device. Also, the system 1000 may be implemented as a server or a personal computer.

The camera 1100 may obtain a still image or a video according to control of a user. The system 1000 may obtain specific information using a still image/video obtained by the camera 1100, or may convert a still image/video into another form of data, such as text, and may store the data. Alternatively, the system 1000 may recognize a string included in the still image/video obtained by the camera 1100 and may provide a text or audio translation corresponding to the string. The application fields of the camera 1100 in the system 1000 have become increasingly diverse as described above. In an example embodiment, the camera 1100 may transmit data, such as a still image/video, to the AP 1800 according to the D-Phy or C-Phy interface according to the MIPI standard.

The display 1200 may be implemented in various forms such as a liquid crystal display (LCD), an organic light emitting diodes (OLED) display, an active-matrix organic light-emitting diode (AM-OLED), a plasma display panel (PDP), a field emission display (FED), electronic paper, or the like. In an example embodiment, the display 1200 may provide a touch screen function and may also be used as an input device of the system 1000. Also, the display 1200 may be integrated with a fingerprint sensor, or the like, and may provide a security function of the system 1000. In an example embodiment, the AP 1800 may transmit image data to be displayed on the display 1200 to the display 1200 according to a D-Phy or C-Phy interface according to the MIPI standard.

The audio processing portion 1300 may process audio data stored in the flash memory device 1600a and 1600b or audio data included in content received from an external entity through the modem 1400 or the I/O device 1700a and 1700b. For example, the audio processing portion 1300 may perform various processing such as coding/decoding, amplification, and noise filtering for audio data.

The modem 1400 may modulate and transmit a signal for wired/wireless data transmission and reception, and may demodulate a signal received from an external entity and may restore an original signal. The I/O device 1700a and 1700b may be a device providing digital input/output, and may include a port which may be connected to an external write medium, an input device such as a touch screen or a mechanical button key, and an output device which may output vibrations using a method such as haptics. In some examples, the I/O device 1700a and 1700b may be connected to an external write medium through a port such as a USB, a lightning cable, an SD card, a micro SD card, a DVD, a network adapter, or the like.

The AP 1800 may control overall operations of the system 1000. Specifically, the AP 1800 may control the display 1200 to display a portion of the content stored in the flash memory device 1600a and 1600b on the screen. Also, when a user input is received through the I/O device 1700a and 1700b, or the like, the AP 1800 may perform a control operation corresponding to the user input.

The AP 1800 may be provided as a system-on-chip (hereinafter, “SoC”) running an application program, an operating system (OS), or the like. Also, the AP 1800 may be included in a single semiconductor package with other devices included in the system 1000, such as a DRAM 1500a, a flash memory 1620, and/or a memory controller 1610. For example, the AP 1800 and at least one other device may be provided in a package form, such as a package on package (PoP), ball grid arrays (BGAs), chip scale packages (CSPs), system in package (SIP), multichip package (MCP), wafer-level fabricated package (WFP), or wafer-level processed stack package (WSP). A kernel of an operating system running on the AP 1800 may include an input/output scheduler (I/O Scheduler) and a device driver for controlling the flash memory device 1600a and 1600b. The device driver may control access performance of the flash memory device 1600a and 1600b by referencing the number of synchronous queues managed by the input/output scheduler, or may control the CPU mode, dynamic voltage and frequency scaling (DVFS) level, or the like, in the SoC.

In an example embodiment, the AP 1800 may include a processor block executing computation or running an application program and/or an operating system, and various other peripheral elements connected to the processor block through a system bus. The peripheral elements may include a memory controller, an internal memory, a power management block, an error detect block, a monitoring block, or the like. The processor block may include one or more cores, and when a plurality of cores are included in the processor block, each of the cores may include a cache memory, and a common cache shared by the cores may be included in the processor block.

In an example embodiment, the AP 1800 may include an accelerator 1820, which is a dedicated circuit for AI data computation. Alternatively, according to an example embodiment, another accelerator chip may be provided separately from the AP 1800, and an accelerator 1820 or an accelerator chip may further be connected to a DRAM 1500b. The accelerator 1820 may be a functional block specializing in performing a specific function of the AP 1800, and may include a graphics processing unit (GPU), a functional block specializing in performing graphic data processing, an neural processing unit (NPU), a block specializing in performing AI calculation and inference, and a data processing unit (DPU), a block specializing in data transmission.

In example embodiments, the system 1000 may include a plurality of DRAMs 1500a and 1500b. In an example embodiment, the AP 1800 may include a controller 1810 for controlling the DRAMs 1500a and 1500b, and the DRAM 1500a may be directly connected to the AP 1800.

The AP 1800 may control the DRAM by setting a command and a mode register set (MRS) complying with the JEDEC standard, or may communicate by setting a DRAM interface protocol for specifications and functions required by the system 1000, such as low voltage/high speed/reliability, and CRC/ECC. For example, the AP 1800 may communicate with the DRAM 1500a using an interface complying with the JEDEC standard, such as LPDDR4 and LPDDR5. Alternatively, the AP 1800 may communicate by establishing a new DRAM interface protocol such that the accelerator chip provided separately from the accelerator 1820 or AP 1800 to control the DRAM 1500b for accelerator having a bandwidth higher than that of the DRAM 1500a.

In FIG. 11, only the DRAMs 1500a and 1500b are illustrated, but the configuration of the system 1000 is not necessarily limited to the illustrated example, and other memories other than the DRAMs 1500a and 1500b may be included in the system 1000 depending on the bandwidth, response speed, and voltage conditions of the AP 1800 or the accelerator 1820. For example, the controller 1810 and/or the accelerator 1820 may control various memories such as PRAM, SRAM, MRAM, RRAM, FRAM, and hybrid RAM. The DRAMs 1500a and 1500b may have relatively low latency and high bandwidth as compared to the I/O device 1700a and 1700b or the flash memory device 1600a and 1600b. The DRAMs 1500a and 1500b may be initialized at the power-on time of the system 1000, and may be used as a temporary storage location for operating system and application data when the operating system and application data are loaded, or may be used as an execute space for various software codes.

In the DRAMs 1500a and 1500b, addition/subtraction/multiplication/division computation and vector computation, address computation, or FFT computation data may be stored. In another example embodiment, the DRAMs 1500a and 1500b may be provided as a processing in memory (PIM) including a computation function. For example, a function for performing inference may be performed in the DRAMs 1500a and 1500b. Here, inference may be performed in a deep learning algorithm using an artificial neural network. The deep learning algorithm may include a training operation of leaning a model through various data and an inference operation of recognizing data with the learned model. For example, the function used for inference may include a hyperbolic tangent function, a sigmoid function, a rectified linear unit (ReLU) function, or the like.

As an example embodiment, an image obtained by a user through a camera 1100 may be signal-processed and stored in the DRAM 1500b, and an accelerator 1820 or an accelerator chip may perform AI data computation of recognizing data using the data stored in DRAM 1500b and a function used for inference.

In example embodiments, the system 1000 may include a plurality of storage having a capacity greater than that of the DRAMs 1500a and 1500b or the plurality of flash memory devices 1600a and 1600b. The flash memory devices 1600a and 1600b may include a controller 1610 and a flash memory 1620. The controller 1610 may receive a control command and data from the AP 1800, and may write data to the flash memory 1620 in response to the control commands or may read data stored in the flash memory 1620 and transmit the data to the AP 1800.

According to an example embodiment, the accelerator 1820 or the accelerator chip may perform a training operation and AI data computation using the flash memory device 1600a and 1600b. In an example embodiment, a block for executing a predetermined computation may be implemented in the flash memory device 1600a and 1600b, and the block may execute at least a portion of the training operation and inference AI data computation performed by the AP 1800 and/or the accelerator 1820 using data stored in the flash memory 1620.

In an example embodiment, the AP 1800 may include an interface 1830, and accordingly, the flash memory device 1600a and 1600b may be directly connected to the AP 1800. For example, the AP 1800 may be implemented as a SoC, the flash memory device 1600a may be implemented as a chip separate from the AP 1800, and the AP 1800 and the flash memory device 1600a may be mounted on a single package. However, an example embodiment thereof is not limited thereto, and the plurality of flash memory devices 1600a and 1600b may be electrically connected to the system 1000 through a connection.

The flash memory device 1600a and 1600b may store data such as a still image/video obtained by the camera 1100, or may store data received through a communication network and/or a port included in the I/O device 1700a and 1700b. For example, the flash memory device 1600a and 1600b may store augmented reality/virtual reality, high definition (HD), or ultrahigh definition (UHD) content.

According to an example embodiment, the system 1000 may be applied with a processing system 100 as described with reference to FIG. 1. For example, the AP 1800 may perform an RMW instruction that loads data stored in a memory space provided by the external DRAMs 1500a and 1500b or the plurality of flash memory devices 1600a and 1600b into a register, modifies the loaded data, and stores the modified data in the memory space.

According to an example embodiment, the AP 1800 may include a register, a general-purpose LSU circuit, and an RMW circuit, and may branch a memory stage of a processing pipeline to the general-purpose LSU circuit and the RMW circuit. After the RMW circuit processes a load operation in response to the RMW instruction, the AP 1800 may control the RMW circuit or the general-purpose LSU circuit to process subsequent instructions having no dependency on the RMW instruction while data is loaded from the memory space into the register in response to the load operation. Accordingly, the period during which the AP 1800 stalls may be reduced, CPI may be reduced, and a throughput may be improved.

According to the aforementioned example embodiments, the processor core may include a general-purpose LSU circuit and also an acceleration circuit for an RMW operation therein, and while an RMW operation is performed in the acceleration circuit, other instructions may be processed using the general-purpose LSU circuit. Accordingly, processing resources may be used efficiently without being occupied by a single RMW operation, and the throughput of the processor core may be improved.

While the example embodiments have been illustrated and described above, it will be configured as apparent to those skilled in the art that modifications and variations could be made without departing from the scope of the present disclosure as defined by the appended claims.

What is claimed is:

1. A processor core, comprising:
an instruction decoder configured to decode a plurality of instructions stored in a program memory;
a register file comprising a plurality of registers;
a general-purpose load store unit (LSU) circuit configured to process a load instruction for loading data stored in a memory into one of the plurality of registers and a store instruction for storing data stored in one of the plurality of registers into the memory; and
a read-modify-write (RMW) circuit configured to process an RMW instruction, the RMW instruction comprising a load operation for loading data stored in the memory into one of the plurality of registers, a compute operation for modifying the loaded data, and a store operation for storing the modified data to the memory,
wherein the instruction decoder is configured to process the RMW circuit to process the load operation in a first clock cycle in response to a first RMW instruction among the plurality of instructions, and
wherein the instruction decoder is configured to control the general-purpose LSU circuit to process a first load instruction or a first store instruction subsequent to the first RMW instruction and having no dependency on the first RMW instruction among the plurality of instructions in a second clock cycle, the second clock cycle being subsequent to the first clock cycle.

2. The processor core of claim 1, wherein the RMW circuit comprises:
an RMW queue configured to queue one or more RMW instructions;
a dependency detector configured to detect dependencies between each of the one or more RMW instructions in the RMW queue and one or more other instructions among the plurality of instructions; and
a dedicated LSU circuit configured to perform the load operation, the compute operation, and the store operation included in each of the one or more RMW instructions.

3. The processor core of claim 2, wherein the dedicated LSU circuit is configured to:
process the load operation in an order in which independent RMW instructions are queued, the independent RMW instructions having no dependencies on each other, and
processes the compute operation and the store operation in an order in which data is loaded into a register included in the register file based on the load operation.

4. The processor core of claim 2, wherein the dedicated LSU circuit is configured to process a subsequent independent RMW instruction when a preceding RMW instruction and one or more dependent RMW instructions dependent on the preceding RMW instruction are completed, the subsequent independent RMW instruction having no dependency on the preceding RMW instructions.

5. The processor core of claim 1, wherein the RMW circuit comprises:
an RMW queue configured to queue one or more RMW instructions;
a dependency detector configured to detect dependencies between each of the one or more RMW instructions in the RMW queue and one or more other instructions among the plurality of instructions; and
a plurality of dedicated LSU circuits configured to process the load operation, the compute operation, and the store operation comprised in each of the one or more RMW instructions, and
wherein the dependency detector is configured to control independent RMW instructions having no dependencies on each other to be processed in parallel in the plurality of dedicated LSU circuits.

6. The processor core of claim 1, wherein the processor core further comprises an RMW detector configured to detect an instruction set that comprises a load instruction, a computation instruction, and a store instruction, which are sequential and for the same register address as the RMW instruction.

7. The processor core of claim 6, wherein the RMW detector is further configured to detect whether the instruction set among instructions comprised in a detection window is smaller than an instruction window comprising the plurality of instructions stored in the program memory.

8. The processor core of claim 1, wherein the instruction decoder is configured to detect the RMW instruction having operation codes different from those of the load instruction, a compute instruction, and the store instruction.

9. The processor core of claim 8, wherein the RMW instruction comprises a register address, an operand, an operator, and a memory address.

10. The processor core of claim 1, comprising a processing pipeline, the processing pipeline comprising a fetching stage, a decoding stage, an executing stage, a memory stage, and a write-back stage,
wherein, in the fetching stage, the RMW detector is configured to detect the first RMW instruction among the plurality of instructions,
wherein, in the decoding stage, the instruction decoder is configured to interpret a register address, an operand, an operator and a memory address of the first RMW instruction,
wherein, in the executing stage, a computation circuit is configured to determine a source address and a destination address by performing a memory address computation,
wherein, in the memory stage, the RMW circuit is configured to process the load operation, the compute operation and the store operation of the first RMW instruction in sequence, and
wherein, in the write-back stage, a write-back circuit is configured to write back a result of the compute operation to a register.

11. The processor core of claim 10,
wherein the memory address comprises a first address indicating the register storing the source address of the memory, and an offset, and
wherein the computation circuit is configured to determine the destination address by adding the offset to the source address.

12. The processor core of claim 10, wherein, while data is loaded into the register corresponding the register address based on the load operation of the first RMW instruction, the general-purpose LSU circuit or the RMW circuit is configured to perform an operation associated with the memory stage among instructions having no dependency on the first RMW instruction.

13. The processor core of claim 10, wherein the processor core is a dual-issue processor core which moves a pair of instructions to a subsequent stage in a clock cycle.

14. An operation method of a processor core, the operation method comprising:
detecting a first read modify write (RMW) instruction among a plurality of instructions stored in a program memory;
computing a memory address of the first RMW instruction;
queuing the first RMW instruction in an RMW queue;
based on the first RMW instruction having no dependency on a preceding instruction, processing a load operation associated with the first RMW instruction;
processing a compute operation for modifying the data loaded into a register based on a load operation;
processing a store operation for storing the modified data into a memory;
dequeuing the first RMW instruction from the RMW queue; and
parallelly processing a second independent RMW instruction subsequent to the first RMW instruction while data stored in the memory is being loaded into the register based on the load operation.

15. The operation method of claim 14, wherein the detecting the first RMW instruction comprises:
detecting a set of a load instruction, a computation instruction, and a store instruction, the set being sequential and having the same register address as the first RMW instruction among instructions included in a detection window among the plurality of instructions.

16. The operation method of claim 14, further comprising:
waiting until processing of an instruction having dependency is completed when the first RMW instruction has dependency on the preceding instructions.

17. The operation method of claim 16, further comprising:
determining another RMW instruction or a store instruction having the same register address as the first RMW instruction among the preceding instructions as the instruction having dependency.

18. A processing system, comprising:
a processor core comprising a register, a general-purpose load store unit (LSU) circuit and a read modify write (RMW) circuit;
a system bus; and
a memory,
wherein, subsequent to the RMW circuit processing a load operation in response to a first RMW instruction and while data is loaded from the memory to the register based on a load operation associated with the first RMW instruction, the processor core is configured to control the RMW circuit or the general-purpose LSU circuit to process a subsequent independent instruction having no dependency on the first RMW instruction.

19. The processing system of claim 18,
wherein the memory comprises a hardware device register, a volatile memory, and a storage device, and
wherein the processor core is configured to access the memory by a memory mapped input/output (MMIO) method.

20. The processing system of claim 18,
wherein the processor core comprises a fetching stage, a decoding stage, an executing stage, a memory stage and a write-back stage, and
wherein operations in the memory stage are performed by the general-purpose LSU circuit or the RMW circuit.
